(19) United States
(12) Patent Application Publication
(10) Pub. No.: US 2007/0136200 A1
(43) Pub. Date: Jun. 14, 2007

(54) Backup broker for private, integral and affordable distributed storage

(75) Inventors: Alexander Frank, Bellevue, WA (US); Bohdan Raciborski, Redmond, WA (US); Ricardo Lopez-Barquilla, Redmond, WA (US); Simon S. Tien, Bellevue, WA (US)

Correspondence Address: MARSHALL, GERSTEIN & BORUN LLP (MICROSOFT), 233 SOUTH WACKER DRIVE, 6300 SEARS TOWER, CHICAGO, IL, 60606, US

(73) Assignee: MICROSOFT CORPORATION, Redmond, WA (US)

(21) Appl. No.: 11/299,349

(22) Filed: Dec. 9, 2005

(51) Int. Cl. G06Q 99/00

(52) U.S. Cl. 705/50

(57) ABSTRACT

A backup broker maintains a list of destination computers that may be ranked according to ability to satisfy quality service requires corresponding to data backup. When a source computer requests that any target file be backed up, the backup broker indicates one or more destination computers meeting a designated quality of service selection. An agent on the source computer encrypts and optionally segments a backup file to form the target file. The agent may then send the file to the backup broker or directly to the destination computer or computers. The backup broker may also periodically test potential and active destination computers to confirm their ability to maintain a designated service level. The backup broker charges for backup according to the requested quality of service selection. The backup broker compensates the destination computer based on its ability to provide consistent service levels and corresponding to the amount of data actually stored.

### BACKGROUND

Computers of all sizes, from handheld devices to large mainframe computers, and related storage and memory devices are all subject to failure at some point. Rotating media such as disk drives, solid state memory such as semiconductor devices, magnetic tape, and any of their predecessors are all subject to damage, mechanical failure, media errors or other failures that render the data stored on them unusable. Not only the value, but the necessity, of backing up stored data has been proven again and again over time. No computer media has yet been made that is so reliable that it does not require backup. Beyond simple media failures, fires and other natural disasters may wipe out not only individual computers but entire systems.

The computing policies in force at many businesses and agencies require not only that backups of computers be made, but also that those backup media are stored some geographic distance from the source. The exact distance may change based on the type of disaster common in a particular area, for example in the U.S. Southeast, where the broad swath of a hurricane may cause damage over a wide area, it may be prudent to save data hundreds or even thousands of miles away from the primary location. On the other hand, in the upper Midwest, 10 or more miles may be all that is required to minimize damage to backup data from a possible tornado.

### SUMMARY

The falling costs of disk space and other memory storage often allows individual computer owners or other business and professional users to purchase vast amounts of disk storage that is often well in excess of any near-term requirement. A backup broker matches sources, that is entities requiring data backup, with providers in possession of unused storage capacity. Backup data sources may be provided with a program or agent for locally encrypting data and optionally segmenting the backup data. The program or agent may also allow a local user to specify certain quality of service selections such as recovery time or a geographic location for storing backup data. The backup data may be routed through the backup broker or sent directly from the source to the destination location specified by the backup broker.

The backup broker may determine a number of redundant copies to be stored, based on the quality of service selections. The backup broker may also periodically check target locations to ensure ongoing compliance with the quality of service selections chosen. The data sources may pay for the backup data services according to the required quality of service and the amount of data stored. The backup broker may move or make additional copies of data as the availability of destination (provider) computers change. Data encryption performed at the source computer helps ensure the privacy of the data, while a digital signature or hash/digest of the data helps ensure the integrity of the data. Multiple backup copies of the data improve the availability of the data when a restore is needed.

Destinations may be compensated for the use of disk space on the computer as well as for maintaining availability and integrity of the data stored. The backup broker may also be compensated for maintaining a registry of available and active destination locations, as well as for monitoring and adjusting storage to maintain quality of service requirements. For example, Third World users with excess storage capacity may provide offshore storage for North American or European users and use the compensation to help offset the cost of the computer.

### BRIEF DESCRIPTION OF THE DRAWINGS

FIG. 1 is a simplified and representative block diagram of a computer network;

FIG. 2 is a block diagram of a computer that may be connected to the network of FIG. 1; and

FIG. 3 is a simplified and representative block diagram of a network topology of connected computers suitable for use in a data backup system.

### DETAILED DESCRIPTION

Although the following text sets forth a detailed description of numerous different embodiments, it should be understood that the legal scope of the description is defined by the words of the claims set forth at the end of this disclosure. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims.

It should also be understood that, unless a term is expressly defined in this patent using the sentence “As used herein, the term ‘_’ is hereby defined to mean . . .” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term by limited, by implication or otherwise, to that single meaning. Finally, unless a claim element is defined by reciting the word “means” and a function without the recital of any structure, it is not intended that the scope of any claim element be interpreted based on the application of 35 U.S.C. § 112, sixth paragraph.

Much of the inventive functionality and many of the inventive principles are best implemented with or in software programs or instructions and integrated circuits (ICs) such as application specific ICs. It is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. Therefore, in the interest of brevity and minimization of any risk of obscuring the principles and concepts in accordance to the present invention, further discussion of such software and ICs, if any, will be limited to the essentials with respect to the principles and concepts of the preferred embodiments.

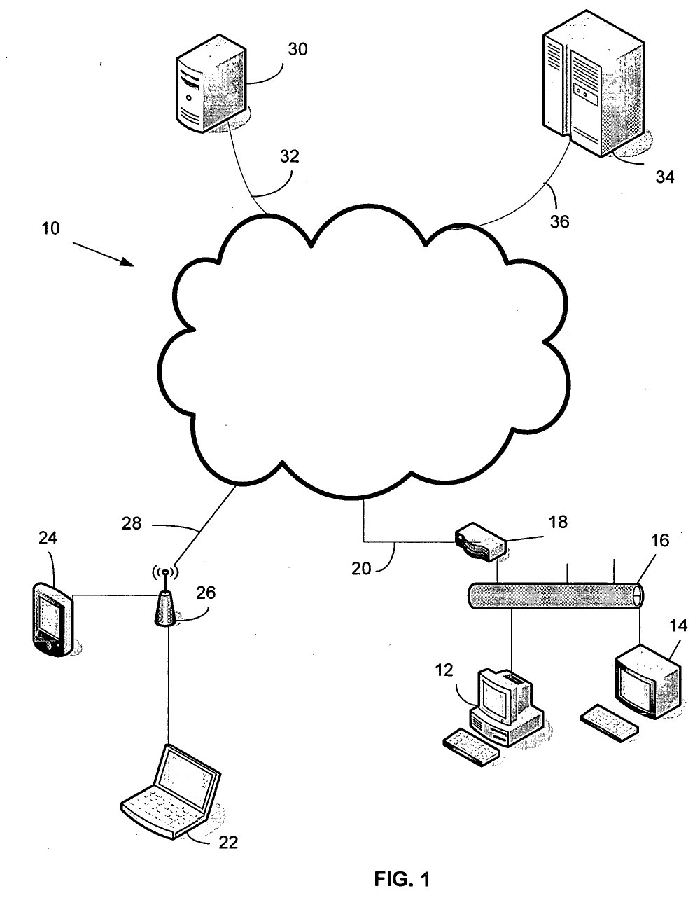

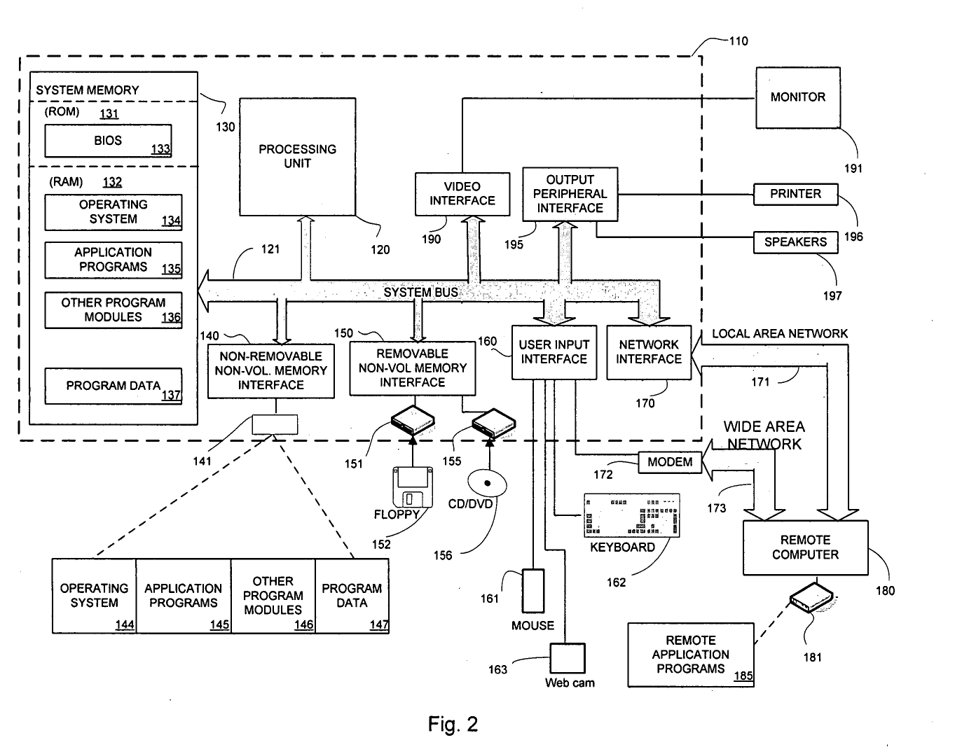

FIGS. 1 and 2 provide a structural basis for the network and computational platforms related to the instant disclosure.

FIG. 1 illustrates a network 10. The network 10 may be the Internet, a virtual private network (VPN), or any other network that allows one or more computers, communication devices, databases, etc., to be communicatively connected to each other. The network 10 may be connected to a personal computer 12, and a computer terminal 14 via an Ethernet 16 and a router 18, and a landline 20. The Ethernet local area network (LAN) 16 may be a subnet of a larger Internet Protocol network. Other networked resources, such as projectors or printers (not depicted), may also be supported via the Ethernet 16 or another data network. On the other hand, the network 10 may be wirelessly connected to a laptop computer 22 and a personal data assistant 24 via a wireless communication station 26 and a wireless link 28. Similarly, a server 30 may be connected to the network 10 using a communication link 32 and a mainframe 34 may be connected to the network 10 using another communication link 36. The network 10 may be useful for supporting peer-to-peer network traffic.

FIG. 2 illustrates a computing device in the form of a computer 110. Components of the computer 110 may include, but are not limited to a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, FLASH memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency, infrared and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 2 illustrates operating system 134, application programs 135, other program modules 136, and program data 137.

The computer 110 may also include other removable/non-removable, volatile/nonvolatile computer storage media. By way of example only, FIG. 2 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 2, provide storage of computer readable instructions, data structures, program modules and other data for the computer 110. In FIG. 2, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 20 through input devices such as a keyboard 162 and cursor control device 161, commonly referred to as a mouse, trackball or touch pad. A camera 163 , such as web camera (webcam), may capture and input pictures of an environment associated with the computer 110, such as providing pictures of users. The webcam 163 may capture pictures on demand, for example, when instructed by a user, or may take pictures periodically under the control of the computer 110. Other input devices (not shown) may include a microphone, joystick, game pad, satellite dish, scanner, or the like. These and other input devices are often connected to the processing unit 120 through an input interface 160 that is coupled to the system bus, but may be connected by other interface and bus structures, such as a parallel port, game port or a universal serial bus (USB). A monitor 191 or other type of display device is also connected to the system bus 121 via an interface, such as a graphics controller 190. In addition to the monitor, computers may also include other peripheral output devices such as speakers 197 and printer 196, which may be connected through an output peripheral interface 195.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 2. The logical connections depicted in FIG. 2 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the input interface 160, or other appropriate mechanism. In a networked environment, program modules depicted relative to the computer 110, or portions thereof, may be stored in the remote memory storage device. By way of example, and not limitation, FIG. 2 illustrates remote application programs 185 as residing on memory device 181.

The communications connections 170 172 allow the device to communicate with other devices. The communications connections 170 172 are an example of communication media. The communication media typically embodies computer readable instructions, data structures, program modules or other data in a modulated data signal such as a carrier wave or other transport mechanism and includes any information delivery media. A “modulated data signal” may be a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Computer readable media may include both storage media and communication media.

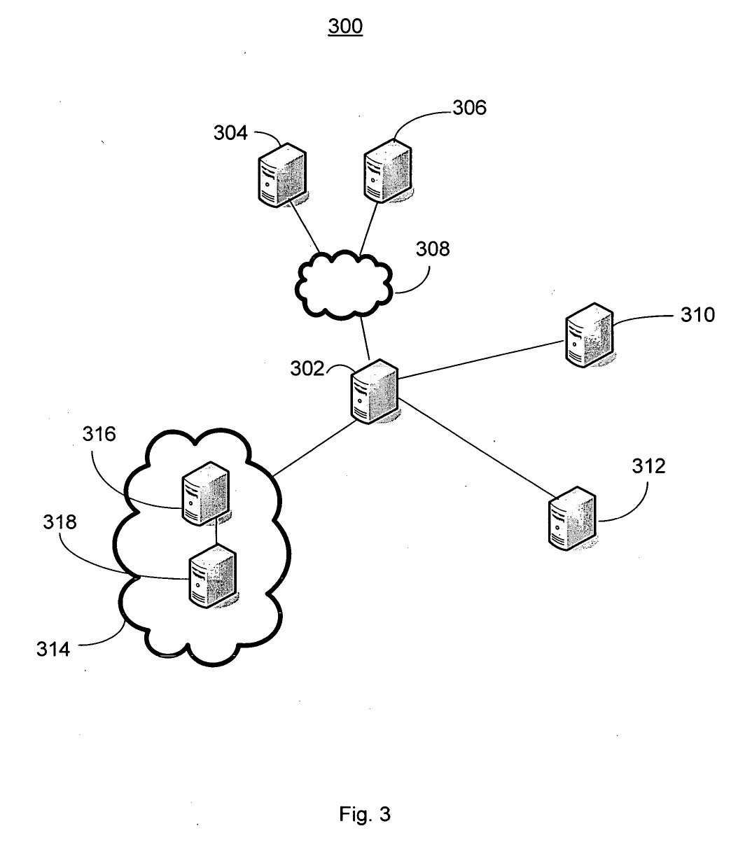

FIG. 3 is a simplified and representative block diagram of a computer network topology suitable for use for data backup. A backup broker 302 may host one or more processes supporting a data backup system 300. The backup broker 302 may be a publicly accessible server serving an open community of participants. The backup broker 302 may also operate in a proprietary environment, for example, a corporation, where only designated computers or those on a particular network are serviced. In either embodiment, the backup broker 302 may be instantiated one a single computer, a confederation of computers, or as a web service. Participant computers 304 and 306 may be coupled via a network 308, such as the Internet or another wide area network. A traditional file server, such as computer 310 may serve traditional or other supplementary backup purposes. Participant computer 312 may be coupled directly to the data backup computer, for example on a local area network, such as LAN 16 of FIG. 1. Additional participant computers 316 318 may be coupled to the backup broker 302 and exist on a private network shown as cloud 314. In one embodiment, cloud 314 may be a remote extension to a corporation's private network. Participant computers may be either a source of backup data, a destination for backup data, or both. An exemplary embodiment presumes that the participant computers may all be owned and operated by separate individuals with no other contractual or business relationships between them. However, as shown in FIG. 3, some computers, such as computers 316 and 318, may be commonly owned and may participate either as a single entity or as individual participants.

In an exemplary embodiment, computer 312 may be designated as a source computer. The source computer 312 may use an agent, backup daemon, or other process to facilitate data backup to one or more remote computers, in cooperation with the backup broker 302. The agent may present a user interface (not depicted) to allow file selection, selection of quality of service requirements and corresponding costs, and provide for local data encryption and digital signature, and, optionally, data segmentation. After a user or automated process has selected one or more files to create a first data file, an encryption process may follow to create a first encrypted file. The first encrypted data file may also be segmented locally into a series of indexed segments. In another embodiment, the segmentation may occur prior to encryption, especially when meaningful data may be recovered from portions of a file. That is, segmenting after encryption will likely require that all segments are recovered before decryption can occur. Thus, if one segment is not available, there is a chance no data at all will be recovered. The encrypted data or encrypted data segments may then be transferred to the backup broker 302 for distribution to other participant computers for storage. In an alternate embodiment, the backup broker 302 may supply endpoint addresses and the source computer 312 may send the data directly to designated participant computers, for example, computers 304 and 306. In yet another embodiment, a secure channel may be set up between the source computer 312 and backup broker 302 and the backup data may be transferred directly to the backup broker 302 for encryption and distribution. This may be the case when the backup broker 302 is a instantiated as a web service instead of a single broker server as shown in this exemplary embodiment. A secure channel approach may also be used when it is not practical to install the agent on the source computer 312 and all backup functions except the file transfer are performed remotely.

Backup metadata, including the number of data segments, redundancy level, quality of service specifications, target storage locations, encryption type, etc. may be stored at the source computer 312, the backup broker 302, or both, depending on preferences or contractual obligations.

Quality of service selections may cover several aspects of the backup storage process. One quality of service selection may be geographic location. The location selection may allow a user to specify the distance from a certain place, for example, a number of miles from a given address or vicinity, such as a ZIP code in the United States. Other location information may include selection of a country, a continent, or a language spoken in the target country. The latter selection may be made as an alternative for selecting a nation or continent.

Another quality of service selection may include reliability and availability levels. One instance may be the specification of a number of redundant storage locations. For example, the user may specify that each backup data segment be stored in at least three separate locations to improve data availability. The number of redundant storage locations may also be dependent on a confidence factor for recovery reliability. The confidence factor may reflect a statistical likelihood that data from a single backup destination is recoverable. Recovery reliability may be a measure of the overall confidence that backup data can be successfully recovered using all destinations. Data accuracy in the recovery process may be assured using hashes or digital signatures of the data. Reliability may also be improved using parity checks to help recover from bit errors or even segment loss. Many factors can contribute to backup recovery issues in normal backup systems, such as, catastrophic media failures (crashes), media errors such as bad spots on disks or tapes, or indexing and labeling errors. Additional factors may be involved in the distributed backup approach, including destination computer failures, destination computer access limited by network outages, renaming or IP address changes, mismanagement by local users, e.g. deleting target data. Recovery reliability may be a measured by monitoring the number of times test data is available and correct compared to the number of tests. Quality of service testing, trend monitoring, and statistical management of target data all may be used to greatly increase recovery reliability.

Yet another quality of service selection may include retrieval speed criteria, that is, the total time from the beginning of a recovery operation to the time all the data segments have been retrieved and forwarded to the source machine. When a request is made for the highest degree of quality of service, e.g. fastest possible retrieval speed, a copy of data may be kept at the traditional file server, such as file server 310, for a premium fee. Another quality of service selection may be a cost criteria. The number of data segments stored or the number of redundant copies maintained may be related to the cost criteria. In one embodiment, advantageous quality of service selections may demand a higher price for backup service.

Quality of service selections may be made separately for each individual backup session or file selection process. Another quality of service selection may allow setting an expiration date for the backup data. Over time, backup data may have a decreasing value as newer data makes the original backup less accurate to current conditions and as additional backups are made. At some point the data may become so out-of-date as to be useless. When operated as part of an overall backup scheme, setting an expiration date may allow cost control and reduce susceptibility to misuse of the backup data.

A default quality of service selection may be made for any or all settings and may use a predetermined list of quality of service selections for convenience. Once specified, the agent may handle the backup of designated files on a routine, predetermined basis or on demand by a user or system administrator.

The agent may also maintain a list or index of each data file or each data file segment that has been transmitted for storage. In one embodiment, the index of files/file segments may be used when rebuilding stored files in a recovery operation. The agent may also maintain a list of encryption keys used to encrypt source data files. Since the original data may be in the clear on the source computer, the encryption keys may not require any more protection than that afforded other sensitive personal or business data. To protect against catastrophic system loss, in a trusted environment, such as a corporation, the keys may also be stored on the backup broker. In a non-trusted environment, a key generation algorithm reference may be stored that the user can use with a passphrase for regeneration of the keys.

The index, or backup metadata, may include owner, backup name, backup type, quality of service selections including redundancy level, file detail, data segment detail including storage location, source system, encryption algorithm, data segmentation algorithm, and hashes or digital signature information. In one embodiment the index or backup metadata may be included with the backup data and backed up as well. Then, the client will need to remember only the index encryption key and hash (unless it is digitally signed).

It may be important that data privacy be maintained. One model is to have the client encrypt/decrypt the backup data locally. In another embodiment, the data may be accessed only after the client is successfully authenticated by the backup broker 302.

The backup broker 302 may perform a number of functions. The backup broker 302 may maintain a list of source data computers, such as computer 312. Source data computers may register with the backup broker or a related service and receive credentials, such as login ID and password, which enable access to the backup broker 302. The backup broker 302 may also store destination data corresponding to one or more destination computers for storing backup data. Similar to source data computers, destination computers may register with the backup broker 302 for verification and selection. Data about destination computers may include name and address, amount of space available for storage, storage agent version, etc.

The backup broker 302 may also store, at least temporarily, the backup data in transit to one or more destination computers, such as computers 306 or 316. In an alternate embodiment, the backup broker 302 may specify one or more destination computer addresses, allowing the backup agent on source computer 312 to directly contact and store the data on the destination computer or computers, using, for example, peer-to-peer networking. In one embodiment, the backup data is encrypted at the source computer 312, meaning data privacy for data in transit or temporarily stored on the backup broker 302 may not be a significant issue.

The backup broker 302 may also monitor both potential destination computers and active destination computers with respect to quality of service measurements. Potential destination computers may register with the backup broker 302 or a similar service. The backup broker 302 may then test, using sample data, quality of service measurements appropriate to backup storage. When characterizing potential destination computers the results may be used to formulate a list of destination computers capable of supporting different levels of service. As discussed above, service levels may be related to available storage capacity, transit time (network delays associated with reaching a particular destination computer), or retrieval latency (the overall time from initial request to receipt of the requested target data), recovery reliability, and accessibility. Other characteristics such as geographic location may also be included in service level characteristics.

When characterizing active destination computers, measurements may be taken to verify that previously determined service levels are still available. When the service levels fall below a designated threshold, the backup broker 302 may need to take several actions. For example, data stored at a destination computer, such as destination computer 316, may need to be moved to another computer, such as destination computer 318, to maintain a previously guaranteed quality of service. In addition, the billing rate for the destination computer 316 may be lowered, reflecting the lower service level. Last, the characterization of the destination computer 316 may be modified on the list of destination computers, reflecting the lower service level. Since the billing for destination computer 316 is lower, a corresponding lowering of the payment rate for the use of storage space on destination computer 316 may also be lowered. One function of the backup computer 302 may be to notify the destination computer 316 that its quality of service has changed and has affected its billing rate. This may allow the operator of the destination computer 316 to take steps to correct and improve the measured service level.

Alternatively, when measurements determine that the original quality of service offered by the destination computer 316 has lowered, the backup broker 302 may simply send an alert to the source computer 312 (or associated user) and request instructions, for example, to maintain the quality of service selection by making additional copies, or accepting the lowered quality of service and, optionally, reduce the payment associated with storage. Because the quality of service measurement may be quite dynamic, rules or thresholds for triggering such activity may be established and agreed to early in the process.

The backup broker 302 may also maintain charge and payment data corresponding to charges for storing data on behalf of a source, such as source computer 312, and payments to destination computers, such as computer 316 and computer 318. Charges and payments may be based not only on the quality of service selection and measured service level but also on the amount of data stored.

In one embodiment, the source computer 312 may be responsible for indexing and cataloging the location of all segments of the target data. In another embodiment, the backup broker 302 is responsible for indexing and cataloging target data destinations. A hybrid is possible, for example, the source computer 312 may maintain an index of segments comprising an individual backup file, while the backup broker 302 may maintain an index of the destination of each of the segments. Therefore, the backup broker 302 has no knowledge of the segment relationships, while the source computer 312 has no knowledge of the segment destinations. Another embodiment may have both the source computer 312 and the backup broker 302 store the index.

The destination computer, for example, computer 318, may also host a storage agent or process that maintains communication with the backup broker 302 and, in some embodiments, the source computer 312. The duties of the storage agent on the destination computer 318 may be to share information about available storage, target files available, and serve as a representative of the backup broker 302 when performing service level measurements. The storage agent may establish active communication with the backup broker 302, such that the backup broker 302 is aware of status changes on the destination computer 318, such as shut down, hibernating, on-line, etc. By monitoring the status of all destination computers, real time information about availability may be offered to customers. The destination computer agent may retrieve requested files or report on availability of target files when contacted by either the backup broker 302 or the source computer 312. The destination computer agent may also purge files meeting expiration criteria, either unilaterally, or upon a message from the backup computer.

When retrieving files, the source computer 312 may use the agent or web service and select a file or files to be restored. The backup broker 302 may use index data to identify and locate the constituent data segments and subsequently retrieve them. The target data may then be returned to the source computer 312 where the agent may assemble the segments and decrypt the file. Obviously, if segmentation was performed before encryption, the reverse order would be followed. The agent may allow location of the recovered file in a particular directory or to overwrite the original file location. In an alternate embodiment, the backup broker 302 may reassembly and decrypt the file and use a secure channel to restore the file requested by the source computer 312. In yet another embodiment, the backup broker 302 may forward endpoint or address data of the target participant computer or computers, for example, 304, 306, 316, 318 to the source computer 312. The source computer 312, may then use the endpoint or address data to retrieve the data segments directly. In some embodiments, the source computer 312 may need to present a token or log in to the backup broker 302 before the recovery process is initiated. The backup broker 302 may authenticate the source computer 312 for security reasons, to protect confidential and/or proprietary information, and may also validate that the account is current (i.e. paid up) before releasing the backup data. In addition to confidentiality of the restored data, this system must guarantee the integrity of the data. In one embodiment, the index may include hashes or digests of the backed up data. In another embodiment, the data may be signed before being backed up. In either case before the data is restored, its integrity may be validated against the hash value (whether it is stored in the index or with the data by means of digital signature).

Although the foregoing text sets forth a detailed description of numerous different embodiments of the invention, it should be understood that the scope of the invention is defined by the words of the claims set forth at the end of this patent. The detailed description is to be construed as exemplary only and does not describe every possibly embodiment of the invention because describing every possible embodiment would be impractical, if not impossible. Numerous alternative embodiments could be implemented, using either current technology or technology developed after the filing date of this patent, which would still fall within the scope of the claims defining the invention.

Thus, many modifications and variations may be made in the techniques and structures described and illustrated herein without departing from the spirit and scope of the present invention. Accordingly, it should be understood that the methods and apparatus described herein are illustrative only and are not limiting upon the scope of the invention.

We claim:

1. A computer-readable medium having computer-executable instructions implementing a method for use by a computer comprising:
encrypting a first data file to form a first encrypted data file;
specifying a quality of service selection;
sending at least a portion of the first encrypted data file to a location specified by a backup broker, remote from the computer; and
conveying the quality of service selection to the backup broker.

2. The computer-readable medium of claim 1, further comprising:
segmenting the encrypted first data file into a plurality of encrypted data segments; and
indexing each of the plurality of encrypted data segments.

3. The computer-readable medium of claim 1, wherein specifying the quality of service selection includes specifying a location requirement.

4. The computer-readable medium of claim 3, wherein the location requirement is one of a distance from a first location, a continent, a native language associated with the location, and a nation.

5. The computer-readable medium of claim 1, wherein specifying the quality of service selection includes specifying one of a number of redundant storage locations and a confidence factor of recovery reliability.

6. The computer-readable medium of claim 1, wherein specifying the quality of service selection includes a retrieval speed criteria.

7. The computer-readable medium of claim 1, wherein specifying the quality of service selection includes specifying a cost criteria.

8. The computer-readable medium of claim 1, further comprising saving information related to the sending the at least a portion of the first encrypted data file to the location specified by the backup broker, the information including at least one of target locations, encryption keys, and hash data corresponding to the at least a portion of the first encrypted data file.

9. A computer adapted for brokering data storage and retrieval comprising:
a network adapter for sending and receiving backup data;
a memory storing a plurality of data elements including:
source data corresponding to a source of backup data;
destination data corresponding to at least one repository for data storage;
target data corresponding to the destination of one or more file segments associated with the backup data;
recovery reliability data corresponding to an ability to retrieve data from the at least one repository;
charge data corresponding to a charge for backing up data;
payment data corresponding to a credit to a repository; and
a processor coupled to the network adapter and the memory for designating the backup file location and sending backup instructions to a source computer.

10. A method of providing storage for backup data comprising:
cataloging a plurality of participant computers for storing the backup data;
receiving the backup data from a customer computer;
determining at least one participant computer from the plurality of participant computers for storing the backup data; and
storing the backup data at the at least one participant computer.

11. The method of claim 10, further comprising receiving a quality of service specification corresponding to storing the backup data.

12. The method of claim 11, wherein determining the at least one participant computer comprises testing each of the plurality of participant computers to determine a quality of service measurement corresponding to the quality of service specification, wherein the testing comprises testing each of the plurality of participant computers for at least one of uptime, retrieval latency, connection speed, and space availability.

13. The method of claim 12, further comprising storing the backup data at a plurality of participant computer locations, wherein a number of participant computer locations used corresponds to the quality of service measurement and the quality of service specification, such that a lower quality of service measurement or a higher quality of service specification will result in using additional participant computer locations.

14. The method of claim 11, wherein determining the at least one participant computer for storing the backup data comprises selecting the at least one participant computer to be in compliance with the quality of service specification.

15. The method of claim 11, further comprising:
testing the at least one participant computer after storing the backup data to determine a quality of service measurement; and
copying the backup data to another participant computer when the quality of service measurement falls below the quality of service specification.

16. The method of claim 11, further comprising:
testing the at least one participant computer after storing the backup data to determine a quality of service measurement; and
sending a notice to the customer computer when the quality of service measurement falls below the quality of service specification.

17. The method of claim 10, further comprising:
segmenting the backup data prior to storing the backup data; and
storing each segment at a different participant computer.

18. The method of claim 10, further comprising:
receiving an expiration date corresponding to the backup data; and
deleting the backup data from the at least one participant computer on the expiration date.

19. The method of claim 10, further comprising:
receiving a request for the backup data;
validating an authority of the request;
retrieving the backup data from the at least one participant computer;
confirming the integrity of the data; and
forwarding the backup data to the customer computer.

20. The method of claim 10, further comprising:
receiving a request for the backup data;
validating an authority of the request;
determining the at least one participant computer used for storing the backup data; and
sending endpoint data corresponding to the at least one participant computer to the customer computer for use in retrieval of the backup data.
